(19) United States
(12) Patent Application Publication
(10) Pub. No.: US 2025/0370899 A1
(43) Pub. Date: Dec. 4, 2025

(54) DEVELOPMENT-TIME SIMULATION OF AN EFFECT OF A REQUESTED CHANGE TO NATIVE CODE

(71) Applicant: Microsoft Technology Licensing, LLC, Redmond, WA (US)

(72) Inventors: Ion TODIREL, Bellevue, WA (US); Bogdan Ionut MIHALCEA, Sammamish, WA (US)

(21) Appl. No.: 18/678,943

(22) Filed: May 30, 2024

(51) Int. Cl. G06F 11/34

(52) U.S. Cl. CPC G06F 11/3457

(57) ABSTRACT

Techniques are described herein that are capable of simulating an effect of a requested change to native code during development of the native code. During development of native code, a user-initiated instruction, which indicates that a change is to be made to the native code, is received. A display instruction, which includes a description of the change and a description of an effect that the change is configured to cause, is generated. An output is generated by executing the native code in absence of the change being made to the native code. Automatic execution of a modification instruction is triggered, which causes a visual representation of the output to be modified. The execution of the modification instruction causes the visual representation to include a simulation of the effect using the description of the change and the description of the effect.

### BACKGROUND

An end-to-end iteration loop (a.k.a. native development inner loop) that is used to develop native code traditionally consumes a substantial amount of time and resources. Native code is code (e.g., software or firmware) that is configured to run on a particular platform (e.g., a particular operating system or a particular processor type). The native development inner loop includes the following operations performed in an iterative loop: editing native code, building the native code, and debugging the native code. Native programming languages often have relatively long build times. A native programming language is a programming language that is used to write native code. For instance, the native programming language may be optimized to run on a particular platform. Examples of a native programming language include but are not limited to C, C++, D, and Rust.

Even a small basic C++ project may take ten to fifteen seconds to build if the project is rebuilt fully. Small changes may take a few seconds, whereas building larger projects may take from hours to days. Modern hardware may not be capable of adequately reducing the amount of time and resource that is consumed by the native development inner loop. For continuous integration (CI) builds, such modern hardware may reduce build times at higher compute costs, for example, by using distributed builds or high-performance build servers.

In a common native development inner loop scenario, a developer types native code in an editor, compiles the native code, links the native code, and then debugs the native code and/or runs tests on the native code. Each of the aforementioned steps may impact performance and productivity of the developer in the native code development process. Compilation and linking often contribute a relatively high proportion of the cost associated with the native code development process.

### SUMMARY

It may be desirable to simulate a change to native code in a native development inner loop in lieu of making the change to the native code. Native code is code (e.g., software or firmware) that is configured to run on a particular platform (e.g., a particular operating system or a particular processor type). Examples of an operating system include but are not limited to a Windows® OS, developed and distributed by Microsoft Corporation; an iOS® operating system (OS), an iPadOS® OS, a macOS® OS, and an OS X® OS, developed and distributed by Apple Inc.; an Android® OS, developed and distributed by Google LLC; and a Linux OS, developed and distributed under the GNU Project. Examples of a processor type include but are not limited to an AMD Ryzen™ processor type, developed and distributed by Advanced Micro Devices, Inc., and an Intel® Core™ processor type, developed and distributed by Intel Corporation.

By simulating a change to native code in a native development inner loop in lieu of making the change to the native code, recompilation and/or relinking of the native code may be avoided (at least in an iteration of the native development inner loop in which the change is requested). In an aspect, simulating the change includes simulating an effect of the change in a visual representation of the output of the native code. In accordance with this aspect, although the native code is executed without making the change, the visual representation reflects the effect of the change as if the change had been made to the native code prior to execution of the native code. The visual representation may be presented to a user (e.g., a developer or an end user) of the native code. In a debugging context in which a developer views the visual representation while debugging the native code, simulating the change to the native code in lieu of making the change increases productivity of the developer (e.g., by avoiding consumption of time that otherwise would have been consumed to recompile and/or relink the native code). In a live server context in which end users view respective visual representations of the output while using the native code as it executes on a server, simulating the change to the native code in lieu of making the change increases reliability and safety of the native code and/or increases productivity of the end users. The change may be simulated for a limited number (e.g., 1, 2, or 3) of end users to assess a potential impact of making the change. Controlling the number of end users who are allowed to observe the simulated effect of the change ensures that the other end users are not negatively affected by the simulated effect.

Various approaches are described herein for, among other things, simulating an effect of a requested change to native code during development of the native code. In an example approach, during development of native code, a user-initiated instruction is received. The user-initiated instruction indicates that a change is to be made to the native code. A display instruction is generated that includes a description of the change and that further includes a description of an effect that the change is configured to cause. An output is generated by executing the native code in absence of the change being made to the native code. Automatic execution of a modification instruction is triggered, which causes a visual representation of the output to be modified, as a result of a triggering event. The execution of the modification instruction causes the visual representation to include a simulation of the effect, which the change is configured to cause, despite the native code being executed in absence of the change being made to the native code, using the description of the change and the description of the effect that are included in the display instruction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example native code effect simulation system in accordance with an embodiment.

FIGS. 2-9 depict flowcharts of example methods for development-time simulation of an effect of a requested change to native code in accordance with embodiments.

FIG. 10 is a block diagram of an example computing system in accordance with an embodiment.

FIG. 11 is a system diagram of an example mobile device in accordance with an embodiment.

FIG. 12 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to simulate a change to native code in a native development inner loop in lieu of making the change to the native code. Native code is code (e.g., software or firmware) that is configured to run on a particular platform (e.g., a particular operating system or a particular processor type). Examples of an operating system include but are not limited to a Windows® OS, developed and distributed by Microsoft Corporation; an iOS® operating system (OS), an iPadOS® OS, a macOS® OS, and an OS X® OS, developed and distributed by Apple Inc.; an Android® OS, developed and distributed by Google LLC; and a Linux OS, developed and distributed under the GNU Project. Examples of a processor type include but are not limited to an AMD Ryzen™ processor type, developed and distributed by Advanced Micro Devices, Inc., and an Intel® Core™ processor type, developed and distributed by Intel Corporation.

By simulating a change to native code in a native development inner loop in lieu of making the change to the native code, recompilation and/or relinking of the native code may be avoided (at least in an iteration of the native development inner loop in which the change is requested). In an aspect, simulating the change includes simulating an effect of the change in a visual representation of the output of the native code. In accordance with this aspect, although the native code is executed without making the change, the visual representation reflects the effect of the change as if the change had been made to the native code prior to execution of the native code. The visual representation may be presented to a user (e.g., a developer or an end user) of the native code. In a debugging context in which a developer views the visual representation while debugging the native code, simulating the change to the native code in lieu of making the change increases productivity of the developer (e.g., by avoiding consumption of time that otherwise would have been consumed to recompile and/or relink the native code). In a live server context in which end users view respective visual representations of the output while using the native code as it executes on a server, simulating the change to the native code in lieu of making the change increases reliability and safety of the native code and/or increases productivity of the end users. The change may be simulated for a limited number (e.g., 1, 2, or 3) of end users to assess a potential impact of making the change. Controlling the number of end users who are allowed to observe the simulated effect of the change ensures that the other end users are not negatively affected by the simulated effect.

Example embodiments described herein are capable of simulating an effect of a requested change to native code during development of the native code. In an example approach, during development of native code, a user-initiated instruction is received. The user-initiated instruction indicates that a change is to be made to the native code. A display instruction is generated that includes a description of the change and that further includes a description of an effect that the change is configured to cause. An output is generated by executing the native code in absence of the change being made to the native code. Automatic execution of a modification instruction is triggered, which causes a visual representation of the output to be modified, as a result of a triggering event. The execution of the modification instruction causes the visual representation to include a simulation of the effect, which the change is configured to cause, despite the native code being executed in absence of the change being made to the native code, using the description of the change and the description of the effect that are included in the display instruction.

Example techniques described herein have a variety of benefits as compared to conventional techniques for handling a requested change to native code during development of the native code. For instance, the example techniques are capable of reducing an amount of time and/or resources (e.g., processor cycles, memory, network bandwidth) that is consumed by a computing system to develop native code. For instance, by generating a display instruction that includes a description of a change to be made to native code and that further includes a description of an effect that the change is configured to cause, generating an output by executing the native code in absence of the change being made to the native code, and triggering automatic execution of a modification instruction, which causes a visual representation of the output to be modified, as a result of a triggering event such that the execution of the modification instruction causes the visual representation to include a simulation of the effect using the description of the change and the description of the effect that are included in the display instruction, the amount of time and resources that otherwise would have been consumed to perform further processing operations (e.g., complication and/or linking) on the native code (i.e., if the change had been made to the native code) may be avoided. By reducing the amount of time and/or resources that is consumed by the computing system to develop the native code, a cost associated with developing the native code may be reduced and/or efficiency of the computing system may be increased.

By generating a display instruction that includes a description of a change to be made to native code and that further includes a description of an effect that the change is configured to cause, generating an output by executing the native code in absence of the change being made to the native code, and triggering automatic execution of a modification instruction, which causes a visual representation of the output to be modified, as a result of a triggering event such that the execution of the modification instruction causes the visual representation to include a simulation of the effect using the description of the change and the description of the effect that are included in the display instruction, the example techniques may increase a user experience and/or an efficiency of a developer who develops the native code and/or an end user who uses the native code. For instance, the user experience and/or the efficiency of the developer may be increased by eliminating a need for the developer to perform one or more operations during development of the native code. For example, the developer may avoid recompiling and/or relinking the native code in at least one iteration of the native development inner loop as a result of simulating an effect of a requested change to the native code rather than making the requested change to the native code. The user experience and/or the efficiency of the end user may be increased by presenting a simulation of the effect of the change to the end user, rather than making the change to the native code that is used by the end user. By presenting the simulation of the effect of the change rather than making the change, the end user may avoid performing operations to remedy potentially negative effects of the change being made.

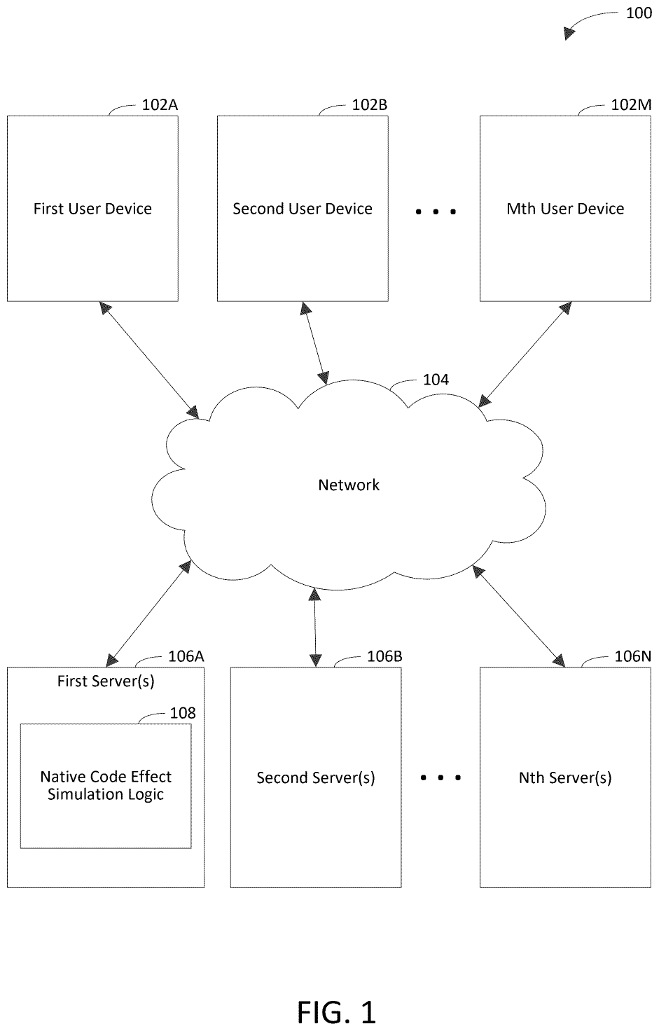

FIG. 1 is a block diagram of an example native code effect simulation system 100 in accordance with an embodiment. Generally speaking, the native code effect simulation system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the native code effect simulation system 100 simulates an effect of a requested change to native code during development of the native code. Detail regarding techniques for simulating an effect of a requested change to native code during development of the native code is provided in the following discussion.

As shown in FIG. 1, the native code effect simulation system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the complex expression-based metadata generation system 100.

One example type of computer program that may be executed by one or more of the servers 106A-106N is a developer tool. A developer tool is a computer program that performs diagnostic operations (e.g., identifying source of problem, debugging, profiling, controlling, etc.) with respect to program code. Examples of a developer tool include an integrated development environment (IDE) and a web development platform. Examples of an IDE include Microsoft Visual Studio® IDE, developed and distributed by Microsoft Corporation; AppCode® IDE, PhpStorm® IDE, Rider® IDE, WebStorm® IDE, etc., developed and distributed by JetBrains s.r.o.; JDeveloper® IDE, developed and distributed by Oracle International Corporation; NetBeans® IDE, developed and distributed by Sun Microsystems, Inc.; Eclipse™ IDE, developed and distributed by Eclipse Foundation; and Android Studio™ IDE, developed and distributed by Google LLC and JetBrains s.r.o. Examples of a web development platform include Windows Azure® platform, developed and distributed by Microsoft Corporation; Amazon Web Services® platform, developed and distributed by Amazon.com, Inc.; Google App Engine® platform, developed and distributed by Google LLC; VMWare® platform, developed and distributed by VMWare, Inc.; and Force.com® platform, developed and distributed by Salesforce, Inc. It will be recognized that the example techniques described herein may be implemented using a developer tool.

Another example type of a computer program that may be executed by one or more of the servers 106A-106N is a cloud computing program (a.k.a. cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include Google Cloud® program, developed and distributed by Google LLC; Oracle Cloud® program, developed and distributed by Oracle Corporation; Amazon Web Services® program, developed and distributed by Amazon.com, Inc.; Salesforce® program, developed and distributed by Salesforce.com, Inc.; AppSource® and Azure® programs, developed and distributed by Microsoft Corporation; GoDaddy® program, developed and distributed by GoDaddy.com LLC; and Rackspace® program, developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include native code effect simulation logic 108 for illustrative purposes. The native code effect simulation logic 108 is configured to simulate an effect of a requested change to native code during development of the native code. In an example implementation, during development of native code, the native code effect simulation logic 108 receives a user-initiated instruction, which indicates that a change is to be made to the native code. The native code effect simulation logic 108, as a result of receiving the user-initiated instruction, generates a display instruction that includes a description of the change and that further includes a description of an effect that the change is configured to cause. The native code effect simulation logic 108 generates an output by executing the native code in absence of the change being made to the native code. The native code effect simulation logic 108 triggers automatic execution of a modification instruction, which causes a visual representation of the output to be modified, as a result of a triggering event. The execution of the modification instruction causes the visual representation to include a simulation of the effect, which the change is configured to cause, despite the native code being executed in absence of the change being made to the native code, using the description of the change and the description of the effect that are included in the display instruction.

The native code effect simulation logic 108 may be implemented in various ways to simulate an effect of a requested change to native code during development of the native code, including being implemented in hardware, software, firmware, or any combination thereof. For example, the native code effect simulation logic 108 may be implemented as computer program code configured to be executed in one or more processors. In another example, at least a portion of the native code effect simulation logic 108 may be implemented as hardware logic/electrical circuitry. For instance, at least a portion of the native code effect simulation logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the native code effect simulation logic 108 may be (or may be included in) a developer tool and/or a cloud computing program, though the scope of the example embodiments is not limited in this respect.

The native code effect simulation logic 108 is shown to be incorporated in the first server(s) 106A for illustrative purposes and is not intended to be limiting. It will be recognized that the native code effect simulation logic 108 (or any portion(s) thereof) may be incorporated in any one or more of the servers 106A-106N, any one or more of the user devices 102A-102M, or any combination thereof. For example, client-side aspects of the native code effect simulation logic 108 may be incorporated in one or more of the user devices 102A-102M, and server-side aspects of native code effect simulation logic 108 may be incorporated in one or more of the servers 106A-106N.

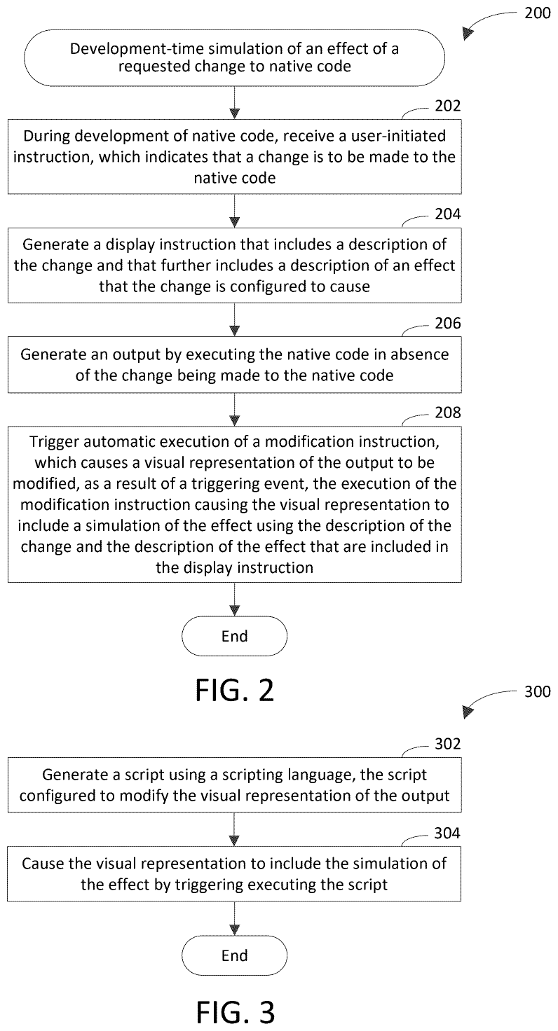

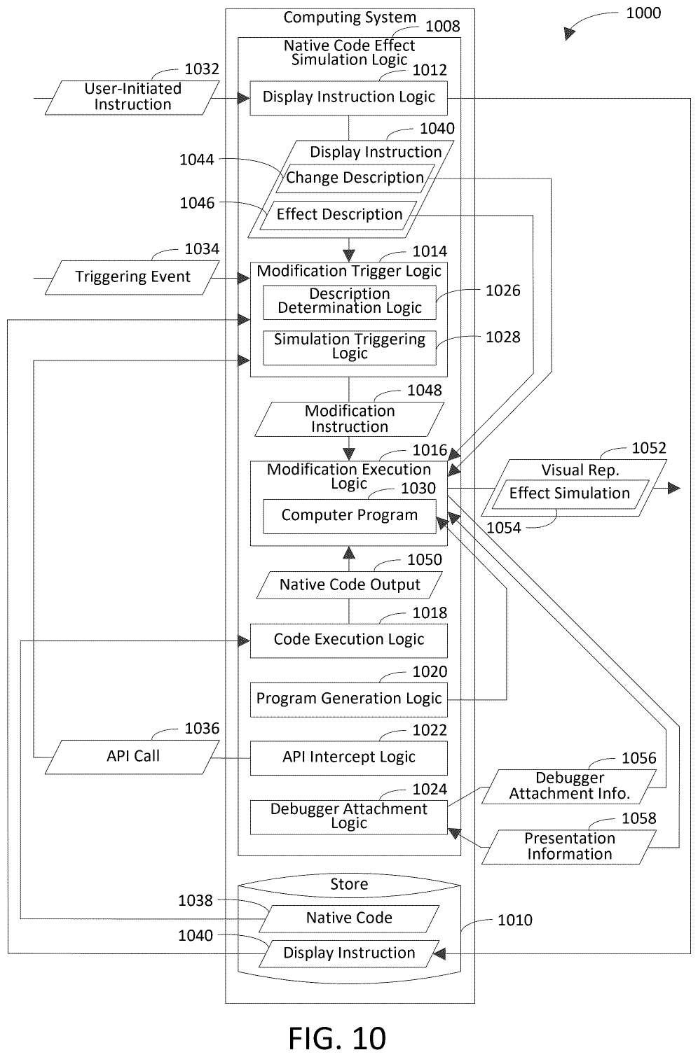

FIGS. 2-9 depict flowcharts 200, 300, 400, 500, 600, 700, 800, and 900 of example methods for development-time simulation of an effect of a requested change to native code in accordance with embodiments. Flowcharts 200, 300, 400, 500, 600, 700, 800, and 900 may be performed by the first server(s) 106A shown in FIG. 1, for example. For illustrative purposes, flowcharts 200, 300, 400, 500, 600, 700, 800, and 900 are described with respect to a computing system 1000 shown in FIG. 10, which is an example implementation of the first server(s) 106A. As shown in FIG. 10, the computing system 1000 includes native code effect simulation logic 1008 and a store 1010. The native code effect simulation logic 1008 includes display instruction logic 1012, modification trigger logic 1014, modification execution logic 1016, code execution logic 1018, program generation logic 1020, API intercept logic 1022, and debugger attachment logic 1024. The modification trigger logic 1014 includes description determination logic 1026 and simulation triggering logic 1028. The modification execution logic 1016 includes a computer program 1030. The store 1010 may be any suitable type of store. One type of store is a database. For instance, the store 1010 may be a relational database, an entity-relationship database, an object database, an object relational database, an extensible markup language (XML) database, etc. The store 1010 is shown to store native code 1038 and a display instruction 1040 for non-limiting, illustrative purposes. Further structural and operational embodiments will be apparent to persons skilled in the relevant art(s) based on the discussion regarding flowcharts 200, 300, 400, 500, 600, 700, 800, and 900.

As shown in FIG. 2, the method of flowchart 200 begins at step 202. In step 202, during development of native code, a user-initiated instruction, which indicates that a change is to be made to the native code, is received. In an aspect, the native code is unmanaged native code. Unmanaged native code is native code whose execution is not managed by a runtime. For example, the unmanaged native code may be compiled to machine code and therefore may be executed by an operating system directly (e.g., rather than being compiled to an intermediate language that is interpreted and executed by a runtime). In an example implementation, during development of native code 1038, the display instruction logic 1012 receives a user-initiated instruction 1032, which indicates that a change is to be made to the native code 1038.

At step 204, as a result of receiving the user-initiated instruction, a display instruction is generated that includes a description of the change and that further includes a description of an effect that the change is configured to cause. In an aspect, the display instruction is executable. In another aspect, the display instruction is not executable. In yet another aspect, the display instruction is generated in lieu of making the change to the native code. In an example implementation, as a result of receiving the user-initiated instruction 1032, the display instruction logic 1012 generates a display instruction 1040 that includes a change description 1044 and an effect description 1046. The change description 1044 is a description of the change indicated by the user-initiated instruction 1032. The effect description 1046 is a description of the effect that the change is configured to cause.

At step 206, an output is generated by executing the native code in absence of the change being made to the native code. In an example implementation, the code execution logic 1018 generates a native code output 1050 by executing the native code 1038 in absence of the change being made to the native code 1038.

At step 208, automatic execution of a modification instruction is triggered, which causes a visual representation of the output to be modified, as a result of a triggering event. The execution of the modification instruction causes the visual representation to include a simulation of the effect, which the change is configured to cause, despite the native code being executed in absence of the change being made to the native code, using the description of the change and the description of the effect that are included in the display instruction. In an example implementation, the modification trigger logic 1014 triggers the modification execution logic 1016 to automatically execute a modification instruction 1048 as a result of a triggering event 1034. In an aspect, the modification trigger logic 1014 detecting the triggering event 1034 triggers the modification trigger logic 1014 to generate the modification instruction 1048. In accordance with this aspect, the modification execution logic 1016 receiving the modification instruction 1048 from the modification trigger logic 1014 triggers the modification execution logic 1016 to modify a visual representation 1052 of the native code output 1050. By executing the modification instruction 1048, the modification execution logic 1016 causes the visual representation 1052 to include an effect simulation 1054, which is a simulation of the effect, despite the native code 1038 being executed by the code execution logic 1018 without the change being made to the native code 1038, using the change description 1044 and the effect description 1046 that are included in the display instruction 1040. For instance, the modification trigger logic 1014 may incorporate the change description 1044 and the effect description 1046 into the modification instruction 1048 before providing the modification instruction 1048 to the modification execution logic 1016.

The modification execution logic 1016 may use artificial intelligence (AI) to perform at least some of its operations. For instance, the modification execution logic 1016 may use the machine learning to analyze (e.g., develop and/or refine an interpretation of) the native code, the output of the native code (and the visual representation thereof), the change (a.k.a. requested change) that is to be made to the native code, the effect that the change is configured to cause, relationships between any of the foregoing factors, and confidences in those relationships. For example, the modification execution logic 1016 may compare attributes of the aforementioned factors and contextual information (which may include sample native code, sample output of the sample native code (and the sample visual representation thereof), sample changes that are to be made to the sample native code, and/or sample effects that the changes are configured to cause) using artificial intelligence to simulate the effect that the change is configured to cause.

In some example embodiments, the modification execution logic 1016 includes a neural network that uses the artificial intelligence to determine (e.g., predict) relationships between the aforementioned factors and the contextual information and confidences in the relationships. The neural network uses those relationships to simulate the effect that the requested change is configured to cause. For example, attributes of the aforementioned factors and the contextual information (which may include example native code, example output of the example native code (and example visual representation thereof), example changes that are to be made to the example native code, and/or example effects that the changes are configured to cause) may be compared to determine similarities and differences between those attributes. In accordance with this example, the neural network may use those similarities and differences to simulate the effect that the requested change is configured to cause.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the modification execution logic 1016 employs a feed forward neural network to train an AI model that is used to determine AI-based confidences. Such AI-based confidences may be used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. For instance, the transformer may be trained to identify the context of each portion using any suitable technique, such as gradient descent.

In an example embodiment, the transformer-based neural network generates an effect simulation model (e.g., to simulate effects that requested changes to native code are configured to cause) by utilizing information, such as native code 1038, the output of the native code 1038 (and the visual representation thereof), the change that is to be made to the native code 1038 (as indicated by the user-initiated instruction 1032), the effect that the change is configured to cause, relationships between any of the foregoing, and AI-based confidences that are derived therefrom.

In some example embodiments, the modification execution logic 1016 includes training logic and inference logic. The training logic is configured to train an AI algorithm that the inference logic uses to determine (e.g., infer) the AI-based confidences. For instance, the training logic may provide sample native code, sample output of the sample native code (and sample visual representation thereof), sample changes that are to be made to the sample native code, and/or sample effects that the changes are configured to cause as inputs to the AI algorithm to train the AI algorithm. The sample data may be labeled. The AI algorithm may be configured to derive relationships between the features (e.g., the native code 1038, the output of the native code 1038 (and the visual representation thereof), the change that is to be made to the native code 1038 (as indicated by the user-initiated instruction 1032), the effect that the change is configured to cause, and contextual information) and the resulting AI-based confidences. The inference logic is configured to utilize the AI algorithm, which is trained by the training logic, to determine the AI-based confidence when the features are provided as inputs to the algorithm.

In an example embodiment, the modification execution logic 1016 includes a generative language model. A generative language model is an AI model that is capable of generating original text output based on sample data. Examples of a generative language model include but are not limited to a generative pre-trained transformer 3 (a.k.a., GPT-3®) model and a generative pre-trained transformer 4(a.k.a. GPT-4®) model, developed and distributed by OpenAI, Inc.; a large language model Meta AI (a.k.a. LLaMA®) model, developed and distributed by Meta Platforms Inc.; a language model for dialogue applications (a.k.a., LaMDA®) model, developed and distributed by Google LLC; and a BigScience large open-science open-access multilingual language model (a.k.a. BLOOM) model, developed and distributed by the BigScience collaborative initiative. A generative language model may use any suitable relevancy determination and/or ranking technique. For instance, the generative language model may use a BM25 (a.k.a. Okapi BM25) ranking function to perform its analysis (e.g., based on keywords).

In another example embodiment, the modification execution logic 1016 includes a large language model (LLM). A large language model is an artificial neural network that is capable of performing natural language processing (NLP) tasks. For instance, the large language model may use a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (a.k.a., PaLM®) model, developed and distributed by Google LLC.

In yet another example embodiment, the modification execution logic 1016 includes an embedding model. An embedding model is an AI model that uses deep learning to convert data into vectors, which represent attributes of the data, and that compares at least a subset of the vectors to determine an extent to which the vectors that are included in the subset are similar. For instance, each vector may represent a semantic meaning of an native code, an output of the native code, a visual representation of the output, a change that is to be made to the native code, or an effect that the change is configured to cause.

In still another example embodiment, the modification execution logic 1016 includes multiple types of AI models. Weights may be applied to the responses generated by the respective types of AI models. For example, the modification execution logic 1016 may include a generative AI model and an embedding model. In accordance with this example, a first weight may be applied to a first response generated by the generative AI model to provide a first weighted response, and a second weight that is different from the first weight may be applied to a second response of the embedding model to provide a second weighted response. The modification execution logic 1016 may combine (e.g., sum) the first weighted response and the second weighted response to generate a response to an AI prompt.

In an example embodiment, triggering the automatic execution of the modification instruction at step 208 includes causing the visual representation to include the simulation of the effect without compiling the native code during a time period that begins at a first time instance at which the user-initiated instruction is received and a second time instance at which the visual representation is caused to include the simulation of the effect.

In another example embodiment, triggering the automatic execution of the modification instruction at step 208 includes causing the visual representation to include the simulation of the effect without linking the native code during a time period that begins at a first time instance at which the user-initiated instruction is received and a second time instance at which the visual representation is caused to include the simulation of the effect.

In yet another example embodiment, triggering the automatic execution of the modification instruction at step 208 includes causing the visual representation to include the simulation of the effect in real-time (e.g., on the fly) as the result of the triggering event.

In still another example embodiment, the triggering event includes encountering a breakpoint in the native code during execution of the native code.

In another example embodiment, the triggering event includes receiving a user-initiated triggering instruction via a user interface, the user-initiated triggering instruction indicating that the visual representation is to be modified to include the simulation of the effect.

In yet another example embodiment, the triggering event includes confirming existence of the display instruction.

In still another example embodiment, the triggering event is a user-defined triggering event that is defined by a developer of the native code.

In an example embodiment, step 202 includes receiving the user-initiated instruction at a debugger during debugging of the native code. In an example implementation, the display instruction logic 1012 includes the debugger, which receives the user-initiated instruction 1032. In an aspect, the debugging is initiated by encountering a breakpoint in the native code during execution of the code. In another aspect, the debugging is initiated by an error occurring during the execution of the native code. For example, the user-initiated instruction may be received during post-mortem debugging. Post-mortem debugging is debugging that occurs as a result of an error in code. In accordance with this aspect, a breakpoint need not necessarily be set in the native code in order for the debugging of the native code to be initiated. In accordance with this embodiment, triggering the automatic execution of the modification instruction at step 208 includes causing the visual representation to include the simulation of the effect in a user interface of the debugger.

In another example embodiment, the method of flowchart 200 includes one or more of the steps shown in flowchart 300 of FIG. 3. As shown in FIG. 3, the method of flowchart 300 begins at step 302. In step 302, a script is generated using a scripting language. The script is configured to modify the visual representation of the output. In an aspect, the script simulates the effect of the change in the visual representation. For example, the script may simulate the output of the native code, including the effect of the change to the native code. The script may be used to perform operations on the native code, including but not limited to annotating the native code, adding semantic information to the native code, and/or patching the native code (e.g., to indicate updated locations of elements (e.g., functions, comments) in the native code, updated types of the native elements, or updated naming of the elements). In another aspect, step 204 of flowchart 200 includes step 302. In an example implementation, the display instruction logic 1012 generates the script. In accordance with this implementation, the display instruction 1012 includes the script.

In an aspect, the script is editable by a user (e.g., a developer or an end user) of the native code. For example, a user interface that includes an interface element, which enables the user to control and manipulate the script, may be presented to the user. In accordance with this example, the script may be modified based on (e.g., based at least on) user-initiated instructions that are received via the interface element. In an example implementation, the display instruction logic 1012 presents the user interface, including the interface element, to the user to enable the user to control and manipulate the script.

At step 304, the visual representation is caused to include the simulation of the effect by triggering execution of the script. In an aspect, step 208 of flowchart 200 includes step 304. In an example implementation, the modification trigger logic 1014 causes the visual representation 1052 to include the effect simulation 1054 by triggering execution of the script. In accordance, with this implementation, the modification trigger logic 1014 provides the script, which is received from the display instruction logic 1012, to the modification execution logic 1016. For instance, the modification trigger logic 1014 may include the script in the modification instruction 1048, which the modification trigger logic 1014 provides to the modification execution logic 1016. In accordance with this implementation, receipt of the script at the modification execution logic 1016 triggers the modification execution logic 1016 to execute the script, which causes the visual representation 1052 to include the simulation of the effect.

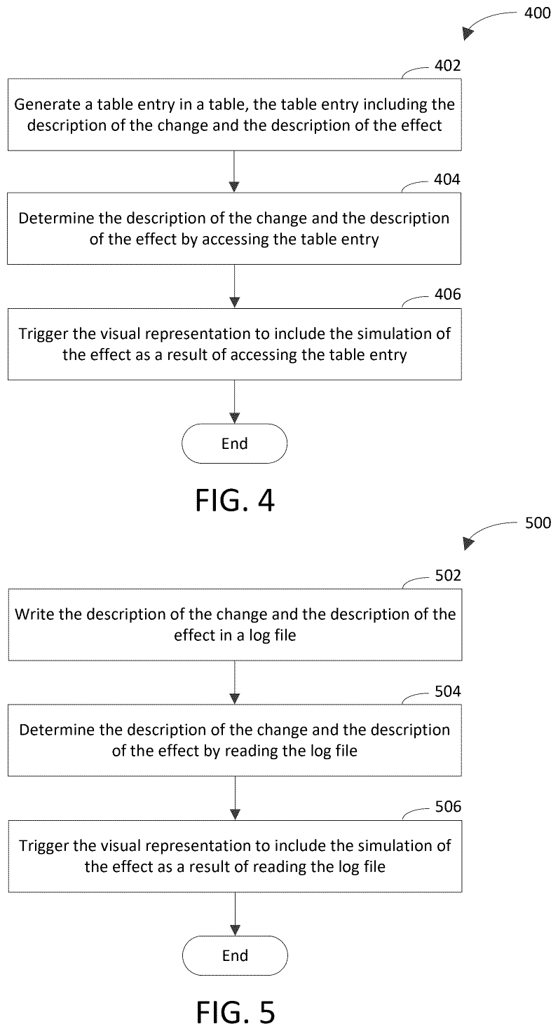

In yet another example embodiment, the method of flowchart 200 includes one or more of the steps shown in flowchart 400 of FIG. 4. As shown in FIG. 4, the method of flowchart 400 begins at step 402. In step 402, a table entry is generated in a table. The table entry includes the description of the change and the description of the effect. In an aspect, step 204 of flowchart 200 includes step 402. In an example implementation, the display instruction logic 1012 generates the table entry in the table. For instance, the display instruction 1040 may include the table entry. In accordance with this implementation, the table entry includes the change description 1044 and the effect description 1046.

At step 404, the description of the change and the description of the effect are determined by accessing the table entry. For instance, the triggering event, which results in triggering the automatic execution of the modification instruction at step 208 of flowchart 200, may include determining the description of the change and the description of the effect by accessing the table entry. In an example implementation, the description determination logic 1026 determines the change description 1044 and the effect description 1046 by accessing the table entry.

At step 406, the visual representation is triggered (e.g., caused) to include the simulation of the effect as a result of accessing the table entry. In an example implementation, the simulation triggering logic 1028 triggers the visual representation 1052 to include the effect simulation 1054 as a result of accessing the table entry (e.g., as a result of determining the change description 1044 and the effect description 1046 by accessing the table entry).

In an aspect, steps 404 and 406 are included in step 208 of flowchart 200.

In still another example embodiment, the method of flowchart 200 includes one or more of the steps shown in flowchart 500 of FIG. 5. As shown in FIG. 5, the method of flowchart 500 begins at step 502. In step 502, the description of the change and the description of the effect are written in a log file. In an aspect, step 204 of flowchart 200 includes step 502. In an example implementation, the display instruction logic 1012 writes the change description 1044 and the effect description 1046 in the log file. For instance, the display instruction 1040 may include the log file.

At step 504, the description of the change and the description of the effect are determined by reading the log file. For instance, the triggering event, which results in triggering the automatic execution of the modification instruction at step 208 of flowchart 200, may include determining the description of the change and the description of the effect by reading the log file. In an example implementation, the description determination logic 1026 determines the change description 1044 and the effect description 1046 by reading the log file.

At step 506, the visual representation is triggered (e.g., caused) to include the simulation of the effect as a result of reading the log file. In an example implementation, the simulation triggering logic 1028 triggers the visual representation 1052 to include the effect simulation 1054 as a result of reading the log file (e.g., as a result of determining the change description 1044 and the effect description 1046 by reading the log file).

In an aspect, steps 504 and 506 are included in step 208 of flowchart 200.

In some example embodiments, one or more steps 202, 204, 206, and/or 208 of flowchart 200 may not be performed. Moreover, steps in addition to or in lieu of steps 202, 204, 206, and/or 208 may be performed. For instance, in an example embodiment, the method of flowchart 200 further includes generating a computer program, which is configured to use the display instruction to modify the visual representation of the output. In an aspect, the computer program is a standalone computer program. In another aspect, the computer program is configured to govern (e.g., control) execution of the native code. In yet another aspect, the computer program is configured to run the script in tandem with the native code. In still another aspect, the computer program is configured to modify the native code (e.g., create a patch on the native code) to reference the script. In an example implementation, the program generation logic 1020 generates the computer program 1030, which is configured to use the display instruction 1040 to modify the visual representation 1052 of the output. In accordance with this embodiment, triggering the automatic execution of the modification instruction at step 208 includes triggering the computer program to cause the visual representation to include the simulation of the effect using the description of the change and the description of the effect that are included in the display instruction. In an example implementation, the modification trigger logic 1014 triggers the computer program 1030 to cause the visual representation 1052 to include the effect simulation 1054 using the change description 1044 and the effect description 1046 that are included in the display instruction 1040. For instance, the computer program 1030 receiving the modification instruction 1048, including the change description 1044 and the effect description 1046, form the modification trigger logic 1014 may trigger the computer program 1030 to cause the visual representation 1052 to include the effect simulation 1054.

In an aspect of this embodiment, the method of flowchart 200 further includes intercepting an application programming interface (API) call that is directed to the native code. In an example implementation, the API intercept logic 1022 intercepts an API call 1036 that is directed to the native code 1038. In accordance with this aspect, triggering the computer program to cause the visual representation to include the simulation of the effect includes providing (e.g., redirecting) the API call to the computer program rather than the native code, which results in the computer program causing the visual representation to include the simulation of the effect using the description of the change and the description of the effect that are included in the display instruction. In an example implementation, the modification trigger logic 1014 provides the API call 1036 to the computer program 1030 rather than to the native code 1038, which results in the computer program 1030 causing the visual representation 1052 to include the effect simulation 1054 using the change description 1044 and the effect description 1046 that are included in the display instruction 1040.

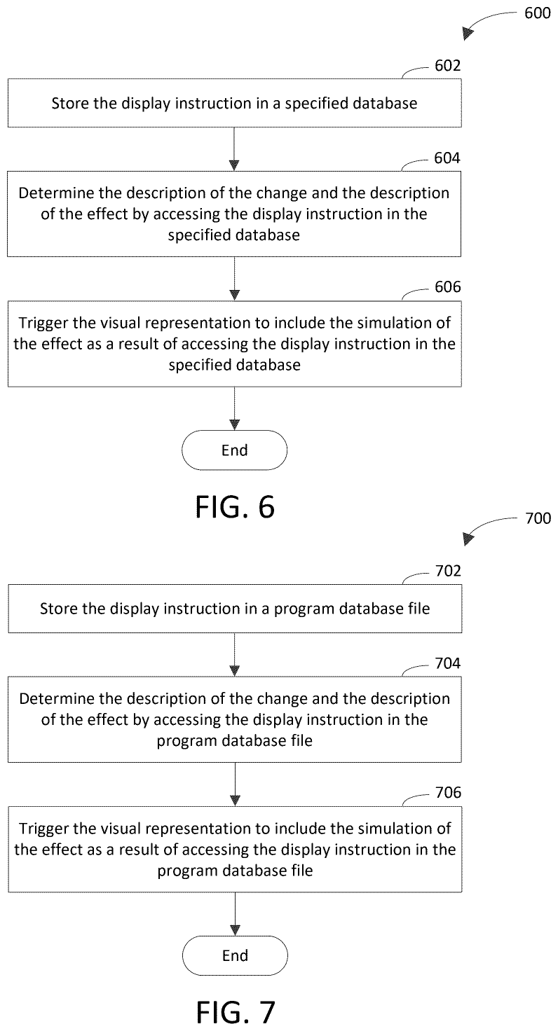

In another example embodiment, the method of flowchart 200 further includes one or more of the steps shown in flowchart 600 of FIG. 6. As shown in FIG. 6, the method of flowchart 600 begins at step 602. In step 602, the display instruction is stored in a specified database. In an example implementation, the display instruction logic 1012 stores the display instruction 1040 in the specified database. For instance, the specified database may be included in the store 1010.

At step 604, the description of the change and the description of the effect are determined by accessing the display instruction in the specified database. In an example implementation, the description determination logic 1026 determines the change description 1044 and the effect description 1046 by accessing the display instruction 1040 in the specified database.

At step 606, the visual representation is triggered to include the simulation of the effect as a result of accessing the display instruction in the specified database. In an example implementation, the simulation triggering logic 1028 triggers the visual representation 1052 to include the effect simulation 1054 as a result of accessing the display instruction 1040 in the specified database.

In an aspect, steps 604 and 606 are included in step 208 of flowchart 200.

In yet another example embodiment, the method of flowchart 200 further includes one or more of the steps shown in flowchart 700 of FIG. 7. As shown in FIG. 7, the method of flowchart 700 begins at step 702. In step 702, the display instruction is stored in a program database file. In an example implementation, the display instruction logic 1012 stores the display instruction 1040 in the program database file. For instance, the program database file may be included in the store 1010.

At step 704, the description of the change and the description of the effect are determined by accessing the display instruction in the program database file. In an example implementation, the description determination logic 1026 determines the change description 1044 and the effect description 1046 by accessing the display instruction 1040 in the program database file.

At step 706, the visual representation is triggered to include the simulation of the effect as a result of accessing the display instruction in the program database file. In an example implementation, the simulation triggering logic 1028 triggers the visual representation 1052 to include the effect simulation 1054 as a result of accessing the display instruction 1040 in the program database file.

In an aspect, steps 704 and 706 are included in step 208 of flowchart 200.

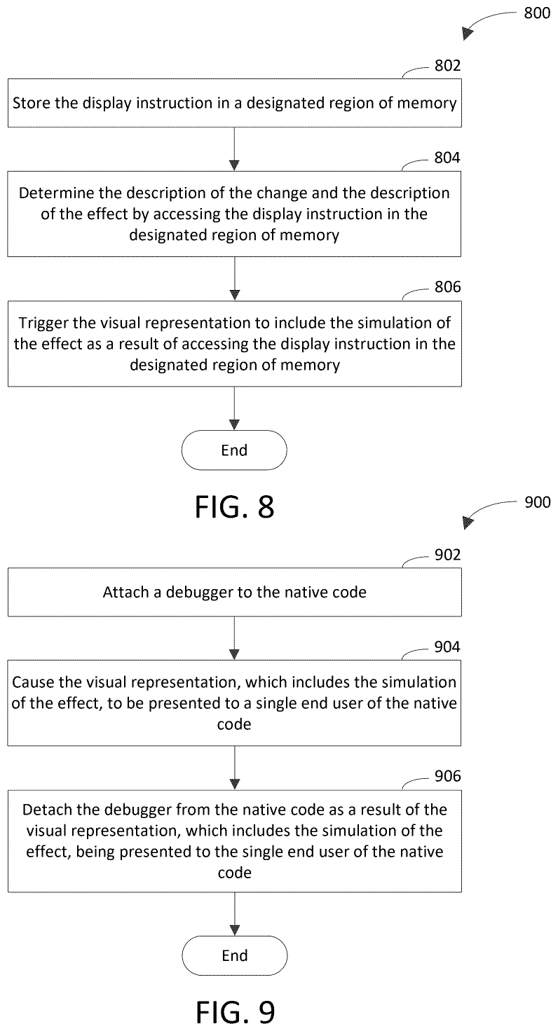

In still another example embodiment, the method of flowchart 200 further includes one or more of the steps shown in flowchart 800 of FIG. 8. As shown in FIG. 8, the method of flowchart 800 begins at step 802. In step 802, the display instruction is stored in a designated region of memory. In an example implementation, the display instruction logic 1012 stores the display instruction 1040 in the designated region of memory. For instance, the designated region of memory may be included in the store 1010. For example, the memory may be the store 1010.

At step 804, the description of the change and the description of the effect are determined by accessing the display instruction in the designated region of memory. In an example implementation, the description determination logic 1026 determines the change description 1044 and the effect description 1046 by accessing the display instruction 1040 in the designated region of memory.

At step 806, the visual representation is triggered to include the simulation of the effect as a result of accessing the display instruction in the designated region of memory. In an example implementation, the simulation triggering logic 1028 triggers the visual representation 1052 to include the effect simulation 1054 as a result of accessing the display instruction 1040 in the designated region of memory.

In an aspect, steps 804 and 806 are included in step 208 of flowchart 200.

In another example embodiment, the method of flowchart 200 further includes one or more of the steps shown in flowchart 900 of FIG. 9. As shown in FIG. 9, the method of flowchart 900 begins at step 902. In step 902, a debugger is attached to the native code. In an example implementation, the debugger attachment logic 1024 attaches the debugger to the native code 1038. In accordance with this implementation, the debugger attachment logic 1024 generates debugger attachment information 1056 to indicate that the debugger is attached to the native code 1038.

At step 904, the visual representation, which includes the simulation of the effect, is caused to be presented to a single end user of the native code. In an aspect, step 208 of flowchart 200 includes step 904. In an example implementation, the modification execution logic 1016 causes the visual representation 1052, which includes the effect simulation 1054, to be presented to a single end user of the native code 1038. For instance, the modification execution logic 1016 may cause the visual representation 1052, including the effect simulation 1054, to be presented to the single end user of the native code 1038 in response to receiving the debugger attachment information 1056 (e.g., in response to the debugger attachment information 1056 indicating that the debugger is attached to the native code 1038). In accordance with this implementation, the modification execution logic 1016 generates presentation information 1058 to indicate that the visual representation 1052, including the effect simulation 1054, has been presented to the single end user of the native code 1038.

At step 906, the debugger is detached from the native code as a result of the visual representation, which includes the simulation of the effect, being presented to the single end user of the native code. In an example implementation, the debugger attachment logic 1024 detaches the debugger from the native code 1038 as a result of the visual representation 1052, which includes the effect simulation 1054, being presented to the single end user of the native code 1038. For instance, the debugger attachment logic 1024 may detach the debugger from the native code 1038 as a result of receiving the presentation information 1058 from the modification execution logic 1016 (e.g., as a result of the presentation information 1058 indicating that the visual representation 1052, including the effect simulation 1054, has been presented to the single end user of the native code 1038).

It will be recognized that the computing system 1000 may not include one or more of the native code effect simulation logic 1008, the store 1010, the display instruction logic 1012, the modification trigger logic 1014, the modification execution logic 1016, the code execution logic 1018, the program generation logic 1020, the API intercept logic 1022, the debugger attachment logic 1024, the description determination logic 1026, the simulation triggering logic 1028, and/or the computer program 1030. Furthermore, the computing system 1000 may include components in addition to or in lieu of the native code effect simulation logic 1008, the store 1010, the display instruction logic 1012, the modification trigger logic 1014, the modification execution logic 1016, the code execution logic 1018, the program generation logic 1020, the API intercept logic 1022, the debugger attachment logic 1024, the description determination logic 1026, the simulation triggering logic 1028, and/or the computer program 1030.

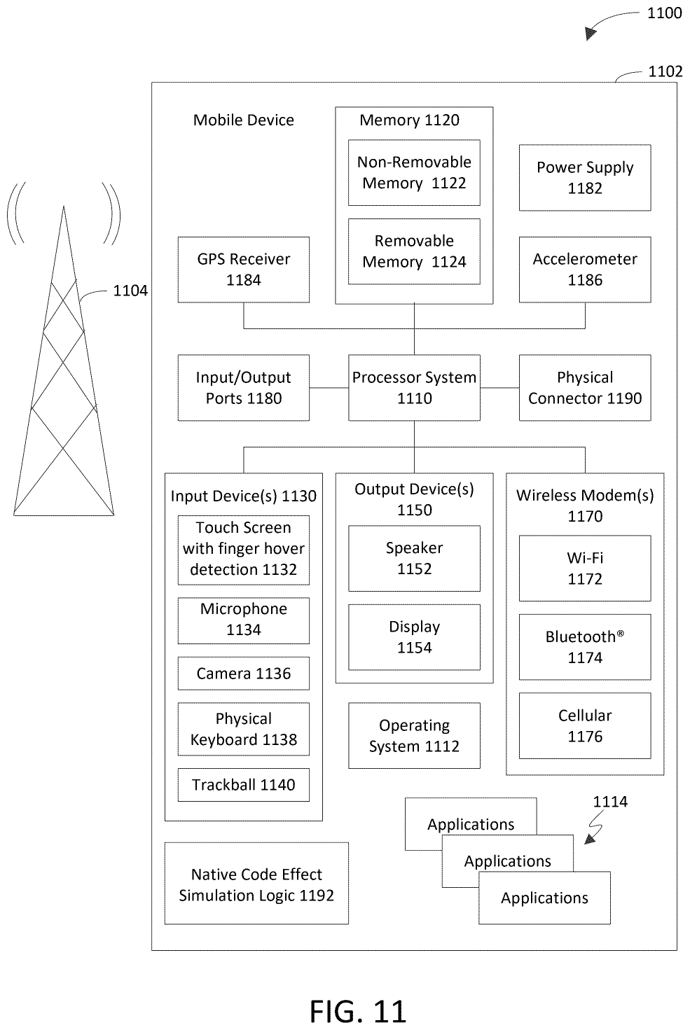

FIG. 11 is a system diagram of an example mobile device 1100 including a variety of optional hardware and software components, shown generally as 1102. Any components 1102 in the mobile device may communicate with any other component, though not all connections are shown, for ease of illustration. The mobile device 1100 may be any of a variety of computing devices (e.g., cell phone, smartphone, handheld computer, Personal Digital Assistant (PDA), etc.) and may allow wireless two-way communications with one or more mobile communications networks 1104, such as a cellular or satellite network, or with a local area or wide area network.

The mobile device 1100 includes a processor system 1110 (e.g., signal processor, microprocessor, ASIC, or other control and processing logic circuitry) for performing such tasks as signal coding, data processing, input/output processing, power control, and/or other functions. An operating system 1112 may control the allocation and usage of the components 1102 and support for one or more applications 1114 (a.k.a. application programs). The applications 1114 may include common mobile computing applications (e.g., email applications, calendars, contact managers, web browsers, messaging applications) and any other computing applications (e.g., word processing applications, mapping applications, media player applications).

The mobile device 1100 includes native code effect simulation logic 1192, which is operable in a manner similar to the native code effect simulation logic 108 described above with reference to FIG. 1 and/or the native code effect simulation logic 1008 described above with reference to FIG. 10.

The mobile device 1100 includes memory 1120. The memory 1120 may include non-removable memory 1122 and/or removable memory 1124. The non- removable memory 1122 may include random access memory (RAM), read-only memory (ROM), flash memory, a hard disk, or other well-known memory storage technologies. The removable memory 1124 may include flash memory or a Subscriber Identity Module (SIM) card, which is well known in Global System for Mobile Communications (GSM) systems, or other well-known memory storage technologies, such as “smart cards.” The memory 1120 may store data and/or code for running the operating system 1112 and the applications 1114. Example data may include web pages, text, images, sound files, video data, or other data sets to be sent to and/or received from one or more network servers or other devices via one or more wired or wireless networks. Memory 1120 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 1100 may support one or more input devices 1130, such as a touch screen 1132, microphone 1134, camera 1136, physical keyboard 1138 and/or trackball 1140 and one or more output devices 1150, such as a speaker 1152 and a display 1154. Touch screens, such as the touch screen 1132, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 1132 may support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) may include piezoelectric or other haptic output devices. Some devices may serve more than one input/output function. For example, touch screen 1132 and display 1154 may be combined in a single input/output device. The input devices 1130 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (e.g., electroencephalography (EEG) and related methods). Thus, in one specific example, the operating system 1112 or applications 1114 may include speech- recognition software as part of a voice control interface that allows a user to operate the mobile device 1100 via voice commands. Furthermore, the mobile device 1100 may include input devices and software that allows for user interaction via a user's spatial gestures, such as detecting and interpreting gestures to provide input to a gaming application.

Wireless modem(s) 1170 may be coupled to antenna(s) (not shown) and may support two-way communications between the processor system 1110 and external devices, as is well understood in the art. The modem(s) 1170 are shown generically and may include a cellular modem 1176 for communicating with the mobile communication network 1104 and/or other radio-based modems (e.g., Bluetooth® 1174 and/or Wi-Fi 1172). At least one of the wireless modem(s) 1170 is typically configured for communication with one or more cellular networks, such as a GSM network for data and voice communications within a single cellular network, between cellular networks, or between the mobile device and a public switched telephone network (PSTN).

The mobile device 1100 may further include at least one input/output port 1180, a power supply 1182, a satellite navigation system receiver 1184, such as a Global Positioning System (GPS) receiver, an accelerometer 1186, and/or a physical connector 1190, which may be a universal serial bus (USB) port, IEEE 1394 (FireWire) port, and/or RS-232 port. The illustrated components 1102 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the native code effect simulation logic 108, the native code effect simulation logic 1008, the store 1010, the display instruction logic 1012, the modification trigger logic 1014, the modification execution logic 1016, the code execution logic 1018, the program generation logic 1020, the API intercept logic 1022, the debugger attachment logic 1024, the description determination logic 1026, the simulation triggering logic 1028, the computer program 1030, flowchart 200, flowchart 300, flowchart 400, flowchart 500, flowchart 600, flowchart 700, flowchart 800, and/or flowchart 900 may be implemented in hardware, software, firmware, or any combination thereof.

For example, any one or more of the native code effect simulation logic 1008, the store 1010, the display instruction logic 1012, the modification trigger logic 1014, the modification execution logic 1016, the code execution logic 1018, the program generation logic 1020, the API intercept logic 1022, the debugger attachment logic 1024, the description determination logic 1026, the simulation triggering logic 1028, the computer program 1030, flowchart 200, flowchart 300, flowchart 400, flowchart 500, flowchart 600, flowchart 700, flowchart 800, and/or flowchart 900 may be implemented, at least in part, as computer program code configured to be executed in one or more processors.

In another example, any one or more of the native code effect simulation logic 1008, the store 1010, the display instruction logic 1012, the modification trigger logic 1014, the modification execution logic 1016, the code execution logic 1018, the program generation logic 1020, the API intercept logic 1022, the debugger attachment logic 1024, the description determination logic 1026, the simulation triggering logic 1028, the computer program 1030, flowchart 200, flowchart 300, flowchart 400, flowchart 500, flowchart 600, flowchart 700, flowchart 800, and/or flowchart 900 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

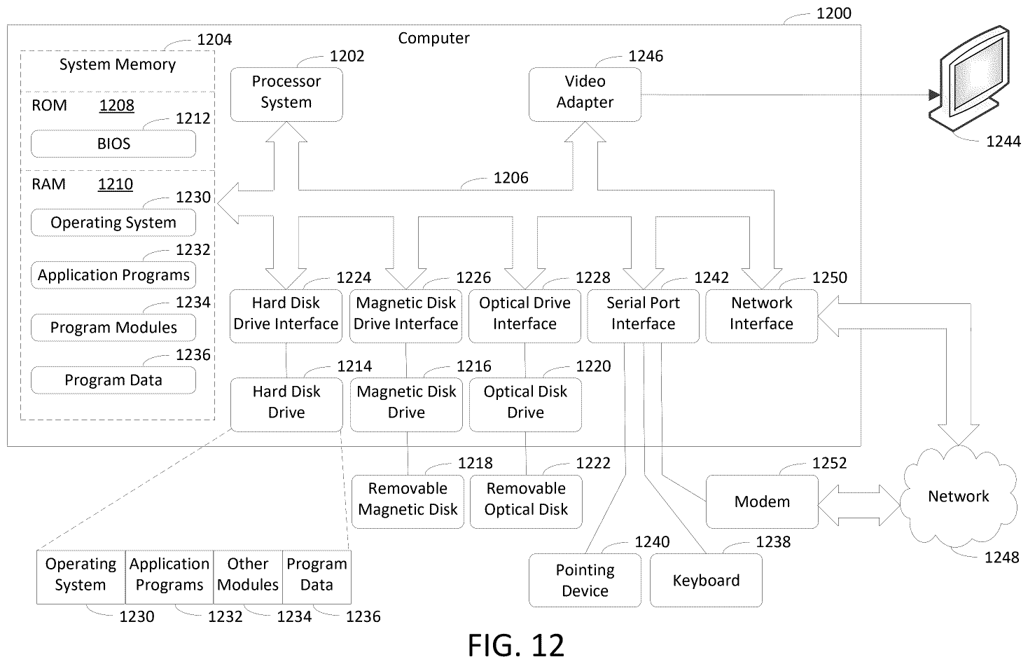

(A1) An example system (FIG. 1, 102A-102M, 106A-106N; FIG. 10, 1000; FIG. 11, 1102; FIG. 12, 1200) comprises a processor system (FIG. 11, 1110; FIG. 12, 1202) and a memory (FIG. 11, 1120, 1122, 1124; FIG. 12, 1204, 1208, 1210) that stores computer-executable instructions. The computer-executable instructions are executable by the processor system to at least, during development of native code (FIG. 10, 1038), receive (FIG. 2, 202) a user-initiated instruction (FIG. 10, 1032), which indicates that a change is to be made to the native code. The computer-executable instructions are executable by the processor system further to at least, as a result of receiving the user-initiated instruction, generate (FIG. 2, 204) a display instruction (FIG. 10, 1040) that includes a description (FIG. 10, 1044) of the change and that further includes a description (FIG. 10, 1046) of an effect that the change is configured to cause. The computer-executable instructions are executable by the processor system further to at least generate (FIG. 2, 206) an output by executing the native code in absence of the change being made to the native code. The computer-executable instructions are executable by the processor system further to at least trigger (FIG. 2, 208) automatic execution of a modification instruction (FIG. 10, 1048), which causes a visual representation (FIG. 10, 1052) of the output to be modified, as a result of a triggering event (FIG. 10, 1034). The execution of the modification instruction causes the visual representation to include a simulation (FIG. 10, 1054) of the effect, which the change is configured to cause, despite the native code being executed in absence of the change being made to the native code, using the description of the change and the description of the effect that are included in the display instruction.

(A2) In the example system of A1, wherein the computer-executable instructions are executable by the processor system to at least: cause the visual representation to include the simulation of the effect without compiling the native code during a time period that begins at a first time instance at which the user-initiated instruction is received and a second time instance at which the visual representation is caused to include the simulation of the effect.

(A3) In the example system of any of A1-A2, wherein the computer-executable instructions are executable by the processor system to at least: cause the visual representation to include the simulation of the effect without linking the native code during a time period that begins at a first time instance at which the user-initiated instruction is received and a second time instance at which the visual representation is caused to include the simulation of the effect.

(A4) In the example system of any of 1-A3, wherein the computer-executable instructions are executable by the processor system to at least: cause the visual representation to include the simulation of the effect in real-time as the result of the triggering event.

(A5) In the example system of any of A1-A4, wherein the computer-executable instructions are executable by the processor system to at least: generate a script using a scripting language, the script configured to modify the visual representation of the output; and cause the visual representation to include the simulation of the effect by triggering execution of the script.

(A6) In the example system of any of A1-A5, wherein the script is editable by a user of the native code.

(A7) In the example system of any of A1-A6, wherein the computer-executable instructions are executable by the processor system to at least: generate a table entry in a table, the table entry including the description of the change and the description of the effect; determine the description of the change and the description of the effect by accessing the table entry; and trigger the visual representation to include the simulation of the effect as a result of accessing the table entry.

(A8) In the example system of any of A1-A7, wherein the computer-executable instructions are executable by the processor system to at least: store the display instruction in a designated region of memory; determine the description of the change and the description of the effect by accessing the display instruction in the designated region of memory; and trigger the visual representation to include the simulation of the effect as a result of accessing the display instruction in the designated region of memory.

(A9) In the example system of any of A1-A8, wherein the computer-executable instructions are executable by the processor system to at least: store the display instruction in a specified database; determine the description of the change and the description of the effect by accessing the display instruction in the specified database; and trigger the visual representation to include the simulation of the effect as a result of accessing the display instruction in the specified database.

(A10) In the example system of any of A1-A9, wherein the computer-executable instructions are executable by the processor system to at least: store the display instruction in a program database file; determine the description of the change and the description of the effect by accessing the display instruction in the program database file; and trigger the visual representation to include the simulation of the effect as a result of accessing the display instruction in the program database file.

(A11) In the example system of any of A1-A10, wherein the computer-description executable instructions are executable by the processor system to at least: write the of the change and the description of the effect in a log file; determine the description of the change and the description of the effect by reading the log file; and trigger the visual representation to include the simulation of the effect as a result of reading the log file.

(A12) In the example system of any of A1-A11, wherein the triggering event comprises a breakpoint being encountered in the native code during execution of the native code.

(A13) In the example system of any of A1-A12, wherein the triggering event comprises receipt of a user-initiated triggering instruction via a user interface, the user-initiated triggering instruction indicating that the visual representation is to be modified to include the simulation of the effect.

(A14) In the example system of any of A1-A13, wherein the triggering event comprises existence of the display instruction being confirmed.

(A15) In the example system of any of A1-A14, wherein the computer-executable instructions are executable by the processor system to at least: during debugging of the native code, receive the user-initiated instruction at a debugger; and cause the visual representation to include the simulation of the effect in a user interface of the debugger.

(A16) In the example system of any of A1-A15, wherein the computer-executable instructions are executable by the processor system to at least: generate a computer program, which is configured to use the display instruction to modify the visual representation of the output; and trigger the computer program to cause the visual representation to include the simulation of the effect using the description of the change and the description of the effect that are included in the display instruction.

(A17) In the example system of any of A1-A16, wherein the computer-executable instructions are executable by the processor system to at least: intercept an application programming interface (API) call that is directed to the native code; and provide the API call to the computer program rather than the native code, which results in the computer program causing the visual representation to include the simulation of the effect using the description of the change and the description of the effect that are included in the display instruction.

(A18) In the example system of any of A1-A17, wherein the computer-executable instructions are executable by the processor system to at least: attach a debugger to the native code; cause the visual representation, which includes the simulation of the effect, to be presented to a single end user of the native code; and detach the debugger from the native code as a result of the visual representation, which includes the simulation of the effect, being presented to the single end user of the native code.

(A19) In the example system of any of A1-A18, wherein the triggering event is a user-defined triggering event that is defined by a developer of the native code.

(B1) An example method is implemented by a computing system (FIG. 1, 102A-102M, 106A-106N; FIG. 10, 1000; FIG. 11, 1102; FIG. 12, 1200). The method comprises, during development of native code (FIG. 10, 1038), receiving (FIG. 2, 202) a user-initiated instruction (FIG. 10, 1032), which indicates that a change is to be made to the native code. The method further comprises, as a result of receiving the user-initiated instruction, generating (FIG. 2, 204) a display instruction (FIG. 10, 1040) that includes a description of the change (FIG. 10, 1044) and that further includes a description of an effect (FIG. 10, 1046) that the change is configured to cause. The method further comprises generating (FIG. 2, 206) an output by executing the native code in absence of the change being made to the native code. The method further comprises triggering (FIG. 2, 208) automatic execution of a modification instruction (FIG. 10, 1048), which causes a visual representation (FIG. 10, 1052) of the output to be modified, as a result of a triggering event (FIG. 10, 1034). The execution of the modification instruction causes the visual representation to include a simulation (FIG. 10, 1054) of the effect, which the change is configured to cause, despite the native code being executed in absence of the change being made to the native code, using the description of the change and the description of the effect that are included in the display instruction.

(B2) In the example method of B1, wherein triggering the automatic execution of the modification instruction comprises: causing the visual representation to include the simulation of the effect without compiling the native code during a time period that begins at a first time instance at which the user-initiated instruction is received and a second time instance at which the visual representation is caused to include the simulation of the effect.

(B3) In the example method of any of B1-B2, wherein triggering the automatic execution of the modification instruction comprises: causing the visual representation to include the simulation of the effect without linking the native code during a time period that begins at a first time instance at which the user-initiated instruction is received and a second time instance at which the visual representation is caused to include the simulation of the effect.

(B4) In the example method of any of B1-B3, wherein triggering the automatic execution of the modification instruction comprises: causing the visual representation to include the simulation of the effect in real-time as the result of the triggering event.

(B5) In the example method of any of B1-B4, wherein generating the display instruction comprises: generating a script using a scripting language, the script configured to modify the visual representation of the output; and wherein triggering the automatic execution of the modification instruction comprises: causing the visual representation to include the simulation of the effect by triggering execution of the script.

(B6) In the example method of any of B1-B5, wherein the script is editable by a user of the native code.

(B7) In the example method of any of B1-B6, wherein generating the display instruction comprises: generating a table entry in a table, the table entry including the description of the change and the description of the effect; and wherein triggering the automatic execution of the modification instruction comprises: determining the description of the change and the description of the effect by accessing the table entry; and triggering the visual representation to include the simulation of the effect as a result of accessing the table entry.

(B8) In the example method of any of B1-B7, further comprising: storing the display instruction in a designated region of memory; wherein triggering the automatic execution of the modification instruction comprises: determining the description of the change and the description of the effect by accessing the display instruction in the designated region of memory; and triggering the visual representation to include the simulation of the effect as a result of accessing the display instruction in the designated region of memory.

(B9) In the example method of any of B1-B8, further comprising: storing the display instruction in a specified database; wherein triggering the automatic execution of the modification instruction comprises: determining the description of the change and the description of the effect by accessing the display instruction in the specified database; and triggering the visual representation to include the simulation of the effect as a result of accessing the display instruction in the specified database.

(B10) In the example method of any of B1-B9, further comprising: storing the display instruction in a program database file; wherein triggering the automatic execution of the modification instruction comprises: determining the description of the change and the description of the effect by accessing the display instruction in the program database file; and triggering the visual representation to include the simulation of the effect as a result of accessing the display instruction in the program database file.

(B11) In the example method of any of B1-B10, wherein generating the display instruction comprises: writing the description of the change and the description of the effect in a log file; and wherein triggering the automatic execution of the modification instruction comprises: determining the description of the change and the description of the effect by reading the log file; and triggering the visual representation to include the simulation of the effect as a result of reading the log file.

(B12) In the example method of any of B1-B11, wherein the triggering event comprises: encountering a breakpoint in the native code during execution of the native code.

(B13) In the example method of any of B1-B12, wherein the triggering event comprises: receiving a user-initiated triggering instruction via a user interface, the user-initiated triggering instruction indicating that the visual representation is to be modified to include the simulation of the effect.

(B14) In the example method of any of B1-B13, wherein the triggering event comprises: confirming existence of the display instruction.

(B15) In the example method of any of B1-B14, wherein receiving the user-initiated instruction comprises: during debugging of the native code, receiving the user-initiated instruction at a debugger; and wherein triggering the automatic execution of the modification instruction comprises: causing the visual representation to include the simulation of the effect in a user interface of the debugger.

(B16) In the example method of any of B1-B15, further comprising: generating a computer program, which is configured to use the display instruction to modify the visual representation of the output; wherein triggering the automatic execution of the modification instruction comprises: triggering the computer program to cause the visual representation to include the simulation of the effect using the description of the change and the description of the effect that are included in the display instruction.

(B17) In the example method of any of B1-B16, further comprising: intercepting an application programming interface (API) call that is directed to the native code; wherein triggering the computer program to cause the visual representation to include the simulation of the effect comprises: providing the API call to the computer program rather than the native code, which results in the computer program causing the visual representation to include the simulation of the effect using the description of the change and the description of the effect that are included in the display instruction.

(B18) In the example method of any of B1-B17, further comprising: attaching a debugger to the native code; wherein triggering the automatic execution of the modification instruction comprises: causing the visual representation, which includes the simulation of the effect, to be presented to a single end user of the native code; and wherein the method further comprises: detaching the debugger from the native code as a result of the visual representation, which includes the simulation of the effect, being presented to the single end user of the native code.

(B19) In the example method of any of B1-B18, wherein the triggering event is a user-defined triggering event that is defined by a developer of the native code.

(C1) An example computer program product (FIG. 11, 1124; FIG. 12, 1218, 1222) comprises a computer-readable storage medium having instructions recorded thereon for enabling a processor-based system (FIG. 1, 102A-102M, 106A-106N; FIG. 10, 1000; FIG. 11, 1102; FIG. 12, 1200) to perform operations. The operations comprise, during development of native code (FIG. 10, 1038), receiving (FIG. 2, 202) a user-initiated instruction (FIG. 10, 1032), which indicates that a change is to be made to the native code. The operations further comprise, as a result of receiving the user-initiated instruction, generating (FIG. 2, 204) a display instruction (FIG. 10, 1040) that includes a description of the change (FIG. 10, 1044) and that further includes a description of an effect (FIG. 10, 1046) that the change is configured to cause. The operations further comprise generating (FIG. 2, 206) an output by executing the native code in absence of the change being made to the native code. The operations further comprise triggering (FIG. 2, 208) automatic execution of a modification instruction (FIG. 10, 1048), which causes a visual representation (FIG. 10, 1052) of the output to be modified, as a result of a triggering event (FIG. 10, 1034). The execution of the modification instruction causes the visual representation to include a simulation (FIG. 10, 1054) of the effect, which the change is configured to cause, despite the native code being executed in absence of the change being made to the native code, using the description of the change and the description of the effect that are included in the display instruction.

### III. Example Computer System

FIG. 12 depicts an example computer 1200 in which embodiments may be implemented. Any one or more of the user devices 102A-102M and/or any one or more of the servers 106A-106N shown in FIG. 1 and/or the computing system 1000 shown in FIG. 10 may be implemented using computer 1200, including one or more features of computer 1200 and/or alternative features. Computer 1200 may be a general-purpose computing device in the form of a conventional personal computer, a mobile computer, or a workstation, for example, or computer 1200 may be a special purpose computing device. The description of computer 1200 provided herein is provided for purposes of illustration, and is not intended to be limiting. Embodiments may be implemented in further types of computer systems, as would be known to persons skilled in the relevant art(s).

As shown in FIG. 12, computer 1200 includes a processor system 1202, a system memory 1204, and a bus 1206 that couples various system components including system memory 1204 to processor system 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic for implementing any one or more of (e.g., at least a portion of) the native code effect simulation logic 1008, the store 1010, the display instruction logic 1012, the modification trigger logic 1014, the modification execution logic 1016, the code execution logic 1018, the program generation logic 1020, the API intercept logic 1022, the debugger attachment logic 1024, the description determination logic 1026, the simulation triggering logic 1028, the computer program 1030, flowchart 200 (including any step of flowchart 200), flowchart 300 (including any step of flowchart 300), flowchart 400 (including any step of flowchart 400), flowchart 500 (including any step of flowchart 500), flowchart 600 (including any step of flowchart 600), flowchart 700 (including any step of flowchart 700), flowchart 800 (including any step of flowchart 800), and/or flowchart 900 (including any step of flowchart 900), as described herein.

A user may enter commands and information into the computer 1200 through input devices such as keyboard 1238 and pointing device 1240. Other input devices (not shown) may include a microphone, joystick, game pad, satellite dish, scanner, touch screen, camera, accelerometer, gyroscope, or the like. These and other input devices are often connected to the processor system 1202 through a serial port interface 1242 that is coupled to bus 1206, but may be connected by other interfaces, such as a parallel port, game port, or a universal serial bus (USB).

A display device 1244 (e.g., a monitor) is also connected to bus 1206 via an interface, such as a video adapter 1246. In addition to display device 1244, computer 1200 may include other peripheral output devices (not shown) such as speakers and printers.

Computer 1200 is connected to a network 1248 (e.g., the Internet) through a network interface or adapter 1250, a modem 1252, or other means for establishing communications over the network. Modem 1252, which may be internal or external, is connected to bus 1206 via serial port interface 1242.

As used herein, the terms “computer program medium” and “computer-readable storage medium” are used to generally refer to media (e.g., non-transitory media) such as the hard disk associated with hard disk drive 1214, removable magnetic disk 1218, removable optical disk 1222, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250 or serial port interface 1242. Such computer programs, when executed or loaded by an application, enable computer 1200 to implement features of embodiments discussed herein. Accordingly, such computer programs represent controllers of the computer 1200.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
during development of native code, receive a user-initiated instruction, which indicates that a change is to be made to the native code;
as a result of receiving the user-initiated instruction, generate a display instruction that includes a description of the change and that further includes a description of an effect that the change is configured to cause;
generate an output by executing the native code in absence of the change being made to the native code; and
trigger automatic execution of a modification instruction, which causes a visual representation of the output to be modified, as a result of a triggering event, the execution of the modification instruction causing the visual representation to include a simulation of the effect, which the change is configured to cause, despite the native code being executed in absence of the change being made to the native code, using the description of the change and the description of the effect that are included in the display instruction.

2. The system of claim 1, wherein the computer-executable instructions are executable by the processor system to at least:
cause the visual representation to include the simulation of the effect without compiling the native code during a time period that begins at a first time instance at which the user-initiated instruction is received and a second time instance at which the visual representation is caused to include the simulation of the effect.

3. The system of claim 1, wherein the computer-executable instructions are executable by the processor system to at least:
cause the visual representation to include the simulation of the effect without linking the native code during a time period that begins at a first time instance at which the user-initiated instruction is received and a second time instance at which the visual representation is caused to include the simulation of the effect.

4. The system of claim 1, wherein the computer-executable instructions are executable by the processor system to at least:
generate a script using a scripting language, the script configured to modify the visual representation of the output; and
cause the visual representation to include the simulation of the effect by triggering execution of the script.

5. The system of claim 4, wherein the script is editable by a user of the native code.

6. The system of claim 1, wherein the computer-executable instructions are executable by the processor system to at least:
generate a table entry in a table, the table entry including the description of the change and the description of the effect;
determine the description of the change and the description of the effect by accessing the table entry; and
trigger the visual representation to include the simulation of the effect as a result of accessing the table entry.

7. The system of claim 1, wherein the triggering event comprises a breakpoint being encountered in the native code during execution of the native code.

8. The system of claim 1, wherein the triggering event comprises receipt of a user-initiated triggering instruction via a user interface, the user-initiated triggering instruction indicating that the visual representation is to be modified to include the simulation of the effect.

9. The system of claim 1, wherein the triggering event comprises existence of the display instruction being confirmed.

10. The system of claim 1, wherein the computer-executable instructions are executable by the processor system to at least:
generate a computer program, which is configured to use the display instruction to modify the visual representation of the output; and
trigger the computer program to cause the visual representation to include the simulation of the effect using the description of the change and the description of the effect that are included in the display instruction.

11. The system of claim 10, wherein the computer-executable instructions are executable by the processor system to at least:
intercept an application programming interface (API) call that is directed to the native code; and
provide the API call to the computer program rather than the native code, which results in the computer program causing the visual representation to include the simulation of the effect using the description of the change and the description of the effect that are included in the display instruction.

12. A method implemented by a computing system, the method comprising:
during development of native code, receiving a user-initiated instruction, which indicates that a change is to be made to the native code;
as a result of receiving the user-initiated instruction, generating a display instruction that includes a description of the change and that further includes a description of an effect that the change is configured to cause;
generating an output by executing the native code in absence of the change being made to the native code; and
triggering automatic execution of a modification instruction, which causes a visual representation of the output to be modified, as a result of a triggering event, the execution of the modification instruction causing the visual representation to include a simulation of the effect, which the change is configured to cause, despite the native code being executed in absence of the change being made to the native code, using the description of the change and the description of the effect that are included in the display instruction.

13. The method of claim 12, wherein triggering the automatic execution of the modification instruction comprises:
causing the visual representation to include the simulation of the effect in real- time as the result of the triggering event.

14. The method of claim 12, further comprising:
storing the display instruction in a designated region of memory;
wherein triggering the automatic execution of the modification instruction comprises:
determining the description of the change and the description of the effect by accessing the display instruction in the designated region of memory; and
triggering the visual representation to include the simulation of the effect as a result of accessing the display instruction in the designated region of memory.

15. The method of claim 12, further comprising:
storing the display instruction in a specified database;
wherein triggering the automatic execution of the modification instruction comprises:
determining the description of the change and the description of the effect by accessing the display instruction in the specified database; and
triggering the visual representation to include the simulation of the effect as a result of accessing the display instruction in the specified database.

16. The method of claim 12, further comprising:
storing the display instruction in a program database file;
wherein triggering the automatic execution of the modification instruction comprises:
determining the description of the change and the description of the effect by accessing the display instruction in the program database file; and
triggering the visual representation to include the simulation of the effect as a result of accessing the display instruction in the program database file.

17. The method of claim 12, wherein generating the display instruction comprises:
writing the description of the change and the description of the effect in a log file; and
wherein triggering the automatic execution of the modification instruction comprises:
determining the description of the change and the description of the effect by reading the log file; and
triggering the visual representation to include the simulation of the effect as a result of reading the log file.

18. The method of claim 12, wherein receiving the user-initiated instruction comprises:
during debugging of the native code, receiving the user-initiated instruction at a debugger; and
wherein triggering the automatic execution of the modification instruction comprises:
causing the visual representation to include the simulation of the effect in a user interface of the debugger.

19. The method of claim 12, further comprising:
attaching a debugger to the native code;
wherein triggering the automatic execution of the modification instruction comprises:
causing the visual representation, which includes the simulation of the effect, to be presented to a single end user of the native code; and
wherein the method further comprises:
detaching the debugger from the native code as a result of the visual representation, which includes the simulation of the effect, being presented to the single end user of the native code.

20. The method of claim 12, wherein the triggering event is a user-defined triggering event that is defined by a developer of the native code.

21. A computer program product comprising a computer-readable storage medium having instructions recorded thereon for enabling a processor-based system to perform operations, the operations comprising:
during development of native code, receiving a user-initiated instruction, which indicates that a change is to be made to the native code;
as a result of receiving the user-initiated instruction, generating a display instruction that includes a description of the change and that further includes a description of an effect that the change is configured to cause;
generating an output by executing the native code in absence of the change being made to the native code; and
triggering automatic execution of a modification instruction, which causes a visual representation of the output to be modified, as a result of a triggering event, the execution of the modification instruction causing the visual representation to include a simulation of the effect, which the change is configured to cause, despite the native code being executed in absence of the change being made to the native code, using the description of the change and the description of the effect that are included in the display instruction.
